(19) United States
(12) Patent Application Publication
(10) Pub. No.: US 2020/0293021 A1
(43) Pub. Date: Sep. 17, 2020

(54) METHOD OF OPTIMIZING MACHINING SIMULATION CONDITION, MACHINING SIMULATION DEVICE, MACHINING SIMULATION SYSTEM AND PROGRAM

(71) Applicant: Mitsubishi Heavy Industries Machine Tool Co., Ltd., Ritto-shi, Shiga (JP)

(72) Inventors: Saneyuki GOYA, Tokyo (JP); Toshiya WATANABE, Tokyo (JP); Haruhiko NIITANI, Ritto-shi (JP); Yoshihito FUJITA, Ritto-shi (JP)

(73) Assignee: Mitsubishi Heavy Industries Machine Tool Co., Ltd., Ritto-shi, Shiga (JP)

(21) Appl. No.: 16/758,004

(22) PCT Filed: Apr. 20, 2018
(86) PCT No.: PCT/JP2018/016317

§ 371 Date: Apr. 21, 2020

(30) Foreign Application Priority Data
Nov. 30, 2017 (JP) 2017-231018

(51) Int. Cl. G05B 19/4069; G05B 19/18; B23K 26/10

(52) U.S. Cl. CPC G05B 19/4069; B23K 26/10; G05B 19/182

(57) ABSTRACT

A method of optimizing a machining simulation condition includes a step of receiving a setting condition of a machine tool at the time of performing a prescribed machining detail, a step of calculating a first machining result that is a machining result assumed when the machine tool performs machining under the received setting condition, a step of acquiring a second machining result that is a machining result when the machine tool performs machining under the received setting condition, and a step of evaluating a degree of coincidence between the first machining result and the second machining result, and repeatedly performs the calculation of the first machining result while changing the precondition of the calculation until the degree of coincidence is equal to or more than a prescribed threshold value.

### TECHNICAL FIELD

The present invention relates to a method of optimizing a machining simulation condition, a machining simulation device, a machining simulation system and a program. Priority is claimed on Japanese Patent Application No. 2017-231018 filed on Nov. 30, 2017, the content of which is incorporated herein by reference.

### BACKGROUND ART

In recent years, efforts have been made to evaluate a machining result by a machine tool and to optimize a machining condition such that the machining result approaches a desired machining result. For example, PTL 1 discloses a technique for storing data that indicates a relationship between a laser irradiation condition (the machining condition) and a machining state of an object to be machined and performing laser machining by selecting an optimal irradiation condition to meet a target specification from the data. According to the technique described in PTL 1, machining can be performed under the machining condition to meet the target, and thus a desired machining result can be obtained.

In addition, efforts have been made to optimize the machining condition by predicting the machining result when various machining conditions are set by the machining simulation and repeating a simulation until appropriate machining conditions to obtain a desired machining detail can be specified.

### CITATION LIST

### Patent Literature

[PTL 1] Japanese Unexamined Patent Application Publication No. 2008-114257

### SUMMARY OF INVENTION

### Technical Problem

In a case where there is a difference between actual machining result and the calculation result by the simulation, and thus it is attempted to improve the difference by adjusting the machining condition, if the simulation model is accurate, the appropriate machining condition can be obtained. However, for example, in a case where machining is performed on a new material, and the like, accuracy of a simulation model that simulates machining for the new material may not be sufficient. Even when the appropriate machining condition can be calculated on the basis of such a simulation model, the machining condition may not be an appropriate machining condition in an actual machine. To solve such a problem, a method for improving the difference between actual machining result and the calculation result by the simulation by efficiently improving the accuracy of the simulation model has not been proposed.

The present invention provides the method of optimizing the machining simulation condition, the machining simulation device, the machining simulation system and the program, which can solve the above-described problem.

### Solution to Problem

According to one aspect of the present invention, a method of optimizing a machining simulation condition by a computer includes a step of receiving a setting condition of a machine tool at the time of performing a prescribed machining detail, a step of calculating a first machining result that is a machining result assumed when the machine tool performs machining under the received setting condition, a step of causing the computer to acquire a second machining result that is a machining result when the machine tool performs machining under the received setting condition, a step of evaluating a degree of coincidence between the first machining result and the second machining result, and a step of changing a precondition of the calculation, in which the computer repeatedly executes the calculation of the first machining result while changing the precondition of the calculation until the degree of coincidence is equal to or more than a prescribed threshold value.

According to one aspect of the present invention, in the step of changing the precondition of the calculation, the precondition of the calculation is adjusted on the basis of measurement information on the precondition of the calculation measured when the machine tool performs machining under the setting condition.

According to one aspect of the present invention, in the step of calculating the first machining result, the machining detail and the setting condition are input and the first machining result is calculated on the basis of a prescribed machining simulation model.

According to one aspect of the present invention, the setting condition is a value that is calculated by an inverse analysis on the basis of the machining simulation model and the machining detail.

According to one aspect of the present invention, the setting condition is a representative value of a range of the setting condition related to an operation of the machine tool that is calculated by an inverse analysis on the basis of the machining simulation model and the machining detail.

According to one aspect of the present invention, the precondition of the calculation includes at least one of a parameter related to a performance of the machine tool included in the machining simulation model and a parameter related to a material of the object to be machined included in the machining simulation model.

According to one aspect of the present invention, the method of optimizing the machining simulation condition further includes a step of accumulating the precondition of the calculation when the degree of coincidence is equal to or more than a prescribed threshold value, and a step of calculating an optimum value of the precondition of the calculation on the basis of the accumulated precondition of the calculation.

According to one aspect of the present invention, the machine tool is a laser machining apparatus.

According to one aspect of the present invention, a machining simulation device includes a reception unit that receives a setting condition of a machine tool at the time of performing a prescribed machining detail, a calculation unit that calculates a first machining result that is a machining result assumed when the machine tool performs machining under the received setting condition, an acquisition unit that acquires a second machining result that is a machining result when the machine tool performs machining under the received setting condition, an evaluation unit that evaluates a degree of coincidence between the first machining result and the second machining result; and a change unit that changes a precondition of the calculation, in which the calculation unit repeatedly executes the calculation of the first machining result while changing the precondition of the calculation until the degree of coincidence is equal to or more than a prescribed threshold value.

According to one aspect of the present invention, a machining simulation system includes a machine tool, and a machining simulation device, in which the machining simulation device acquires a machining detail and a setting condition in machining executed by the machine tool to optimize a machining simulation condition.

According to one aspect of the present invention, a program is the program for causing a computer to execute a method of optimizing a machining simulation condition, the program causes a computer to execute a step of receiving a setting condition of a machine tool at the time of performing a prescribed machining detail, a step of calculating a first machining result that is a machining result assumed when the machine tool performs machining under the received setting condition, a step of causing the computer to acquire a second machining result that is a machining result when the machine tool performs machining under the received setting condition, a step of evaluating a degree of coincidence between the first machining result and the second machining result, and a step of changing a precondition of the calculation, wherein the computer repeatedly performs the calculation of the first machining result while changing the precondition of the calculation until the degree of coincidence is equal to or more than a prescribed threshold value.

### Advantageous Effects of Invention

According to the above-described method of optimizing the machining simulation condition, the machining simulation device, the machining simulation system and the program, the machining simulation model that simulates machining of the machine tool with high accuracy can be constructed.

### BRIEF DESCRIPTION OF DRAWINGS

FIG. 1 is a block diagram showing an example of a simulation system in each embodiment according to the present invention.

FIGS. 2A and 2B are diagrams showing examples of machining details and setting conditions in a first embodiment according to the present invention.

FIG. 3 is a first flowchart showing an example of optimization processing of a simulation model in the first embodiment according to the present invention.

FIG. 4 is a second flowchart showing an example of optimization processing of a simulation model in the first embodiment according to the present invention.

FIG. 5 is a diagram explaining a range of the setting condition in the first embodiment according to the present invention.

FIG. 6 is a diagram explaining adjustment processing of an internal parameter in the first embodiment according to the present invention.

FIG. 7 is a diagram explaining optimization processing of a simulation model in a second embodiment according to the present invention.

FIG. 8 is a flowchart showing an example of optimization processing of a simulation model in the second embodiment according to the present invention.

FIG. 9 is a diagram showing an example of a hardware configuration of a simulation device according to the present invention.

### DESCRIPTION OF EMBODIMENTS

### First Embodiment

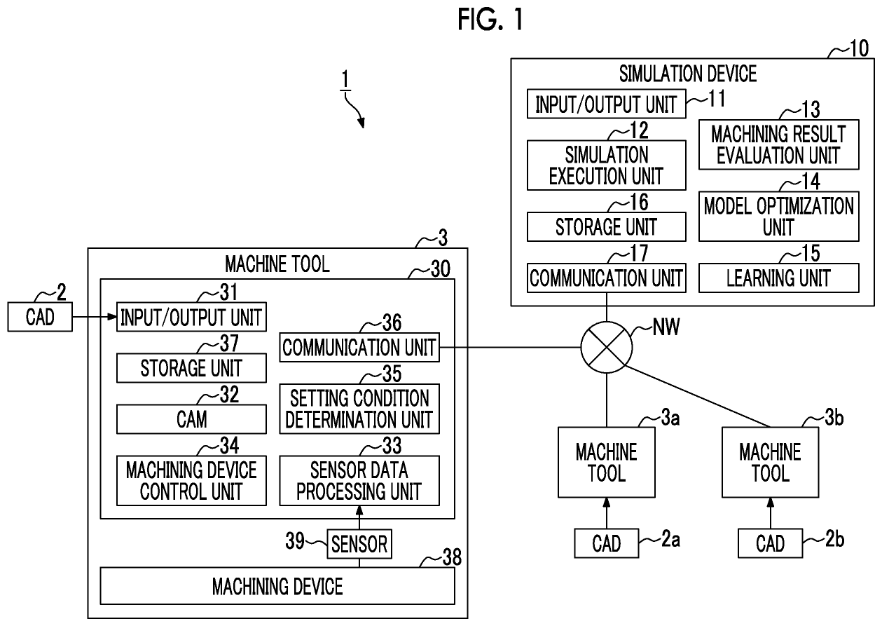

Hereinafter, a simulation system for a machine tool according to a first embodiment of the present invention will be described with reference to FIGS. 1 to 6.

FIG. 1 is a block diagram showing an example of a simulation system in each embodiment according to the present invention. A simulation system 1 provides a simulation function of simulating machining by machine tools 3, 3a, and 3b and calculating a machining result assumed when the machine tool 3 or the like performs machining. As shown in FIG. 1, the simulation system 1 includes a simulation device 10, the machine tools 3, 3a, and 3b, and a computer aided design (CAD) systems 2, 2a, and 2b. The simulation device 10 and the machine tools 3, 3a, and 3b are communicably connected via a network (NW). The machine tools 3, 3a, and 3b are collectively referred to as a machine tool 3, and the CAD systems 2, 2a, and 2b are collectively referred to as a CAD system 2. In the simulation system 1, the numbers of the simulation devices 10, the machine tool 3, and the CAD system 2 are not limited to the illustrated numbers. For example, two or more simulation devices 10 may be included, and one or four or more machine tools 3 and CAD systems 2 may be included. In addition, the machine tools 3, 3a, and 3b may be installed in different factories, respectively, or may be installed in one factory. The simulation device 10 and the CAD system 2 are computers provided with a central processing unit (CPU) such as a server, for example.

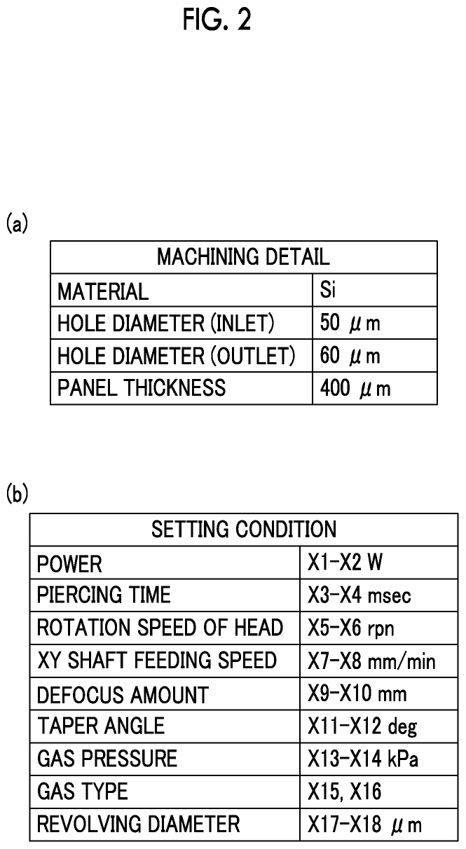

With respect to machining performed by the machine tool 3, the simulation device 10 simulates machining by the machine tool 3, and calculates a machining result by inputting a machining detail and a setting condition to a simulation model for machining. Then, the simulation device 10 provides the machining result to a user. Here, the machining detail is a request and a specification of machining for an object to be machined. In addition, the setting condition is an operating condition (the machining condition) of the machine tool 3 set on the machine tool 3 for performing appropriate machining. The machining detail and a range of the setting condition will be described with reference to FIGS. 2A and 2B.

FIGS. 2A and 2B are diagrams showing examples of machining details and setting conditions in a first embodiment according to the present invention. An example of the machining detail in FIG. 2A includes the machining detail showing that a tapered hole in which hole diameter of an inlet is “50 μm” and hole diameter of an outlet is “60 μm” are formed on a member which is made of “Si” and has a panel thickness of “400 μm”. Further, the machining detail includes not only items related to a shape such as the hole diameter and a hole depth but also items related to quality. The items related to the quality include, for example, a cross-sectional area of deteriorated layers, a height of burrs, a size of deposits, and surface roughness.

FIG. 2B shows an example of the range of the setting condition for realizing the machining detail. FIG. 2B shows an example of the setting condition in a case where the machine tool 3 is a laser machining apparatus. The setting condition of the laser machining apparatus include, for example, power of a laser to be output, piercing time, rotation speed of a revolving head of the laser, XY shaft feeding speed, defocus amount, a taper angle, gas pressure of an assist gas, a gas type, a revolving diameter of the laser, and the like. As shown in the figs, a value of each item of the setting condition is given in a range in the present embodiment. As will be described later, the range of each item is a range determined in consideration of influence according to disturbance such as installation environment of the machine tool and an individual difference (the material) of the object to be machined.

The user of the machine tool 3 confirms whether a desired machining result can be obtained under the input setting condition by inputting the machining detail and a value selected from the range of the setting condition to the simulation device 10 and referring to the machining result calculated by the simulation device 10. The user adjusts the value of the setting condition selected from the range of the setting condition until the desired machining result is obtained. When an appropriate setting condition is obtained, the user sets the setting condition in the machine tool 3 and starts actual machining on the object to be machined. Thereby, the setting condition for obtaining a desired object to be machined can be efficiently set.

When the simulation device 10 is used in this way, the user can obtain an appropriate setting condition for obtaining the desired machining result before performing actual machining. However, in a case where the simulation by the simulation device 10 deviates from actual machining by the machine tool 3, there is a possibility that the setting condition set by the simulation device 10 is not appropriate, and the quality of the machining result by the machine tool 3 is not sufficient. To solve such a problem, the simulation device 10 has a function of adjusting various parameters of an analysis model used for the machining simulation. The various parameters are parameters related to the function and performance of the machine tool 3 or parameters related to the material of the object to be machined. In the present embodiment, the accuracy of the simulation model can be improved by adjusting the various parameters depending on actual machining by the machine tool 3 and the object to be machined, and the machining result calculated by the simulation device 10 can be closer to actual machining result.

The simulation device 10 includes an input/output unit 11, a simulation execution unit 12, a machining result evaluation unit 13, a model optimization unit 14, a learning unit 15, a storage unit 16, and a communication unit 17.

The input/output unit 11 acquires, for actual machining performed in the machine tool 3, machining detail information that is information indicating the machining detail, setting condition information that is information indicating the setting condition in machining, and machining result information that is information indicating the machining result. Further, the machining result information includes, for example, information on an image of photographing the object to be machined after machining and the shape or the quality obtained by analyzing the image, and information on a measurement result of a prescribed portion of the object to be machined after machining.

The simulation execution unit 12 inputs the machining detail information and the setting condition information, and calculates the machining result by a prescribed simulation model. Hereinafter, the machining result calculated by the simulation execution unit 12 is referred to as simulation result information. The simulation result information includes information on the shape and the quality of a machining product, such as a two-dimensional image and a three-dimensional image of the machining product. The simulation execution unit 12 simulates machining by laser machining or cutting by a known analysis method such as a finite element method or a first principle calculation. The simulation execution unit 12 performs the simulation by executing, for example, a program for a computer aided engineering (CAE). The simulation model included in the simulation execution unit includes, for example, various calculation formulas (calculation formulas for analyzing a diameter of a machining hole, a machining depth, width of a machining groove, and the like) executed in the program for CAE, and parameters to apply to the formulas. The parameters include internal parameters (parameters related to the performance of the machine tool 3 and parameters related to the material) that are set internally, in addition to external parameters that set the machining detail information and the setting condition information that are input from the outside. For example, in a case where the machine tool 3 is the laser machining apparatus, when the item of the material of the machining detail information is “Si”, the simulation execution unit 12 sets a prescribed value corresponding to the material “Si” for a value of absorptance of laser light of the material of the object to be machined among the internal parameters related to the material of the simulation model. Alternatively, among the internal parameters related to the performance of the machine tool 3 and the like of the simulation model, the simulation execution unit 12 sets the prescribed value according to a change due to aging for the output of a laser oscillator and an optical system (for example, the performance of lens) of the laser machining apparatus. For example, in a case where an operation time of the machine tool 3 is less than X hours, the simulation execution unit 12 sets the output of the laser oscillator to 100% and a transmittance of the lens to 100%. In a case where the operation time is equal to or longer than X time, the simulation execution unit 12 sets the output of the laser oscillator to 90% and the transmittance of the lens to 90%. Here, the fact that the output of the laser oscillator is 90% indicates that only 90% of the specified output is actually output, and the fact that the transmittance of the lens is 90% indicates that only 90% of the output of the oscillator is transmitted due to deterioration of the lens.

Further, the simulation execution unit 12 has an inverse analysis analysis function of setting detail information on the basis of the simulation model when the machining detail information is given. An inverse analysis method includes, for example, an inverse formulation method, an output error method, a minimum variance estimation method, or the like.

The machining result evaluation unit 13 compares the machining result information acquired by the input/output unit 11 with the simulation result information calculated by the simulation execution unit 12, and evaluates the simulation result by the simulation execution unit 12.

The model optimization unit 14 performs processing of optimizing the simulation performed by the simulation execution unit 12. For example, the model optimization unit 14 optimizes the simulation by adjusting the values of the internal parameters of the simulation model on the basis of the evaluation result by the machining result evaluation unit 13.

The learning unit 15 learns the values of the internal parameters optimized by the model optimization unit 14 to further improve the accuracy of the simulation model.

The storage unit 16 stores the machining detail information, the setting condition information, the machining result information, the values of the internal parameters of the simulation model, and the like in machining performed by the machine tool 3. Further, the storage unit 16 stores a large number of the machining result information received from a plurality of different machine tools such as the machine tools 3, 3a, and 3b in association with the machining detail information and the setting condition information at that time. Further, the description will be given under the assumption that the storage unit 16 is arranged in the simulation device 10. However, of course, the storage unit 16 may be arranged at a place connectable from the simulation device 10 via a network (NW).

The communication unit 17 communicates with the machine tool 3. For example, the communication unit 17 receives the machining result information from the machine tool 3.

The machine tool 3 is, for example, the laser machining apparatus that performs the machining by irradiating the laser light. The machine tool 3 includes a control device 30, a machining device 38, and a sensor 39.

The control device 30 is, for example, a computer including a micro processing unit (MPU) such as a microcomputer. The control device 30 controls an operation of the machining device 38 on the basis of the machining detail information, and machines the object to be machined.

The machining device 38 is a main body of a machine tool including the laser oscillator, a head driving mechanism, an assist gas injection mechanism, an installation mechanism of the object to be machined, a user operation panel, and the like.

The sensor 39 is sensors for measuring a machining result and a machining environment, such as a camera, an X-ray computed tomography (CT), a vibration sensor, a displacement sensor, a thermometer, and a scanner. The sensor 39 may be included in the machining device 38, or may be a single sensor independent of the machining device 38. The sensor 39 measures the shape of the object to be machined, the machining environment (a temperature, a vibration, and a position during machining), and the like.

In the machine tool 3, the control device 30 controls the operation of the machining device 38 by allowing only the setting condition within the prescribed range as illustrated in FIG. 2B. The control device 30 includes an input/output unit 31, a computer aided manufacturing (CAM) system 32, a sensor data processing unit 33, a machining device control unit 34, a setting condition determination unit 35, a communication unit 36, and a storage unit 37.

The input/output unit 31 receives an input of the operation information and the setting condition input from the operation panel by the user, and receives an input of CAD data indicating the shape of the object to be machined from a CAD system 2. The CAD data includes the machining detail information. In addition, the input/output unit 31 outputs information to be notified to the user to a display provided on the operation panel.

The CAM system 32 generates a numerical control (NC) data for machining from the CAD data acquired by the input/output unit 31.

The sensor data processing unit 33 acquires measurement information (the measured value and the image) acquired by the sensor 39 measuring the object to be machined, and generates the machining result information by calculating other information related to the machining as necessary. For example, the sensor data processing unit 33 calculates the hole diameter (the diameter of the machining hole) by analyzing the image of the object to be machined, or calculates a taper angle using the calculated hole diameter or the like. A known method is used as an image analysis method when calculating the hole diameter.

The machining device control unit 34 controls the operation of the machining device 38 on the basis of the NC data generated by the CAM system 32 and the setting condition information, and performs machining.

The setting condition determination unit 35 determines whether or not the input setting condition is included in a range of a prescribed setting condition.

The communication unit 36 communicates with the simulation device 10. For example, the communication unit transmits the machining result information to the simulation device 10.

The storage unit 37 stores information such as the CAD data acquired by the input/output unit 31.

The user inputs the machining detail information and the setting condition information to the simulation device 10 before performing machining with the machine tool 3, and causes the simulation device 10 to execute the simulation. The user adjusts the setting condition with reference to the simulation result, and repeats the operation of causing the simulation device 10 to execute the simulation again until the simulation result satisfies the request. As a result, an appropriate setting condition for certain machining detail is determined, and a mass production of the object to be machined is enabled. For that purpose, as described above, high accuracy is required for the simulation by the simulation device 10. Next, a simulation optimization method of the simulation device 10 will be described.

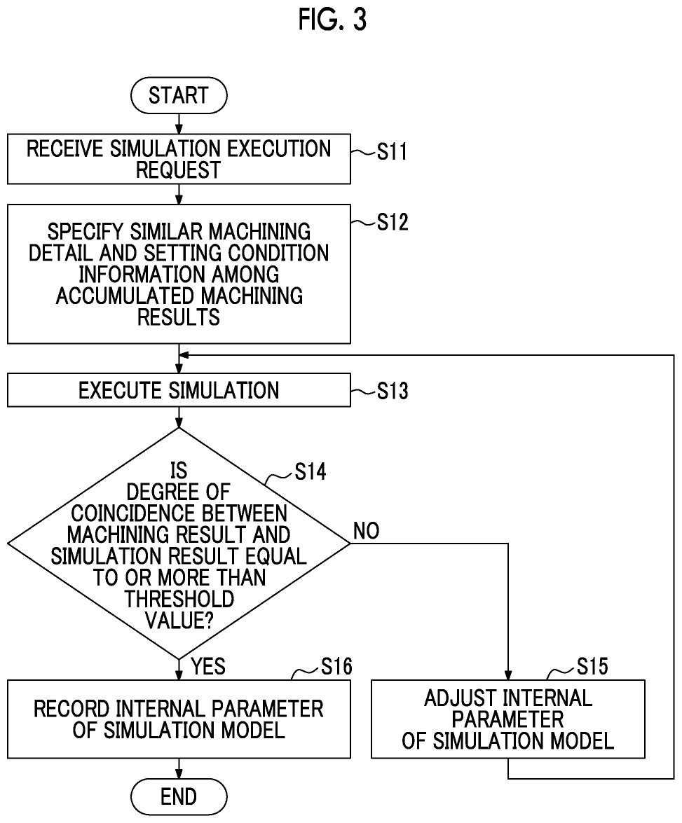

FIG. 3 is a first flowchart showing an example of optimization processing of a simulation model in the first embodiment according to the present invention.

As an assumption, for example, it is assumed that a simulation model having high accuracy needs to be constructed, such as when machining of a new product made of a material that has not been handled before is started, when a variation occurs in the machining accuracy by the machine tool 3, and when it is necessary to review the setting condition reflecting the change due to the aging of the machine tool 3. Further, the storage unit 16 stores the machining detail information, the setting condition information, and the machining result information in various machining executed by the machine tool 3 in the past in association with each other.

First, the user inputs the machining detail information and information requesting execution of the simulation to the simulation device 10. For example, the input/output unit 11 displays a screen (an interface image) displaying an input field for the machining detail information, a simulation execution instruction button on the display connected to the simulation device 10, and the user inputs the machining detail information and the simulation execution instruction from the screen. Then, the input/output unit 11 receives the input of the machining detail information and the simulation execution request (step S11), and stores the machining detail information input in the storage unit 16. Next, the model optimization unit 14 selects the machining result information similar to the machining detail information input by the user among the machining result information accumulated in the storage unit 16, and specifies the machining detail information and the setting condition information stored in association with the selected machining result information (step S12). The model optimization unit 14 sets the specified machining detail information and setting condition information as input parameters of the simulation model. In addition, the simulation execution unit 12 sets a prescribed initial value to the internal parameters related to the performance and the like of the machine tool 3 and the internal parameters related to the material. For example, the simulation execution unit 12 sets the output of the oscillator to 100% and the transmittance of the lens to 100% for the internal parameters related to the performance and the like of the machine tool 3. Further, for example, the model optimization unit 14 sets the absorptance of the material to 100% for the internal parameters related to the material.

Next, the simulation execution unit 12 executes the machining simulation on the basis of the simulation model (step S13), and calculates the simulation result. The machining result evaluation unit 13 compares the machining result information selected in step S12 with the simulation result information to evaluate the degree of coincidence (step S14). For example, the machining result evaluation unit 13 calculates a difference between the hole diameter of the machining result information and the hole diameter of the simulation result information, and in a case where the difference is within the prescribed range, the machining result evaluation unit 13 evaluates that the degree of coincidence with respect to the hole diameter in the machining result is equal to or more than a threshold value and in a case where the difference is out of the range, the machining result evaluation unit 13 evaluates that the degree of coincidence is less than a threshold value. The degree of coincidence is evaluated for the items related to the shape and the quality in the machining detail information. In the example of FIG. 2A, the machining result evaluation unit 13 evaluates the “hole diameter (an inlet)” and the “hole diameter (an outlet)” related to the shape.

In a case where the degree of coincidence of all items is equal to or more than a threshold value (step S14; YES), since the simulation result calculated by the simulation execution unit 12 is almost equal to the machining result when actually machined with machine tool 3 and the accuracy of the simulation model is sufficiently high, it is considered that the adjustment of the internal parameters is not necessary. The model optimization unit stores the currently set internal parameters (the internal parameters related to the performance and the like of the machine tool 3, the internal parameters related to the material) in the storage unit 16 in association with the machining detail information, the setting condition information, the simulation result information, and the degree of coincidence (step S16), and ends the processing of the flowchart.

In a case where there are the items of which the degree of coincidence is less than a threshold value (step S14; No), the model optimization unit 14 adjusts the internal parameters (step S15). For example, in a case where actual machining result information indicates a machining state in which laser power is less than the simulation result (the machining depth is shallow, or the like), it is considered that the laser light is reflected due to influence of the shape and a surface state of the object to be machined, and the actual absorptance may be less than initially assumed, for example. On the basis of such an assumption, the model optimization unit 14 performs adjustment such as reducing the absorptance of the material from 100% to 90% among the internal parameters related to the material. It is predetermined by associating with the items having the difference between the machining result information and the simulation result information that which internal parameters are chosen and how the internal parameters are adjusted. The internal parameters include a reflectance of a mirror, vignetting of the laser light on the lens and the mirror, a focal position, a beam diameter, and the like, in addition to the output of the oscillator, the transmittance of the lens, and the absorptance of the material. Alternatively, the learning unit 15 learns the items having the difference, the difference, and a relationship between the internal parameters to be adjusted and adjustment amount, and the model optimization unit 14 may adjust the parameters on the basis of the learning result. After adjusting the internal parameters, the processing from step S13 is repeated. Thereafter, the simulation execution unit 12 repeatedly executes the calculation of the simulation result while changing the internal parameters until the degree of coincidence between the machining result information and the simulation result information becomes equal to or more than a threshold value. When the degree of coincidence becomes equal to or more than a threshold value, the simulation execution unit 12 stores values of the adjusted internal parameters, the machining detail information, the setting condition information, the simulation result information, and degree of coincidence in the storage unit in association with each other. In addition, the input/output unit 11 displays a fact that the optimization of the simulation is ended on the display to notify the user.

According to the simulation device 10 of the present embodiment, the accuracy of the simulation model can be improved and the machining simulation having the high accuracy can be executed by adjusting the internal parameters. Using the machining simulation having high accuracy, the user can find an appropriate setting condition to be set on the machine tool 3 without actually performing machining. Thereby, the efficiency of the machining operation can be improved.

On the basis of the machining result information and the like stored when machining was performed in the past, a method of optimizing the machining simulation (an off-line optimization method) is described in FIG. 3. Next, while actually performing machining with the machine tool 3 and referring to the result, a method of optimizing the machining simulation (an on-line optimization method) will be described.

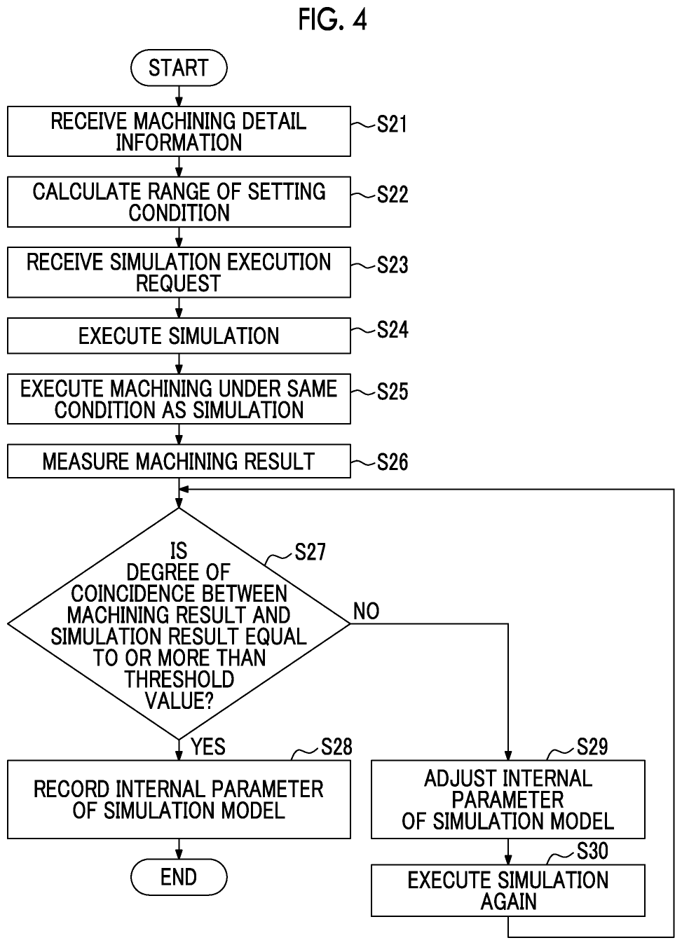

FIG. 4 is a second flowchart showing an example of optimization processing of a simulation model in the first embodiment according to the present invention.

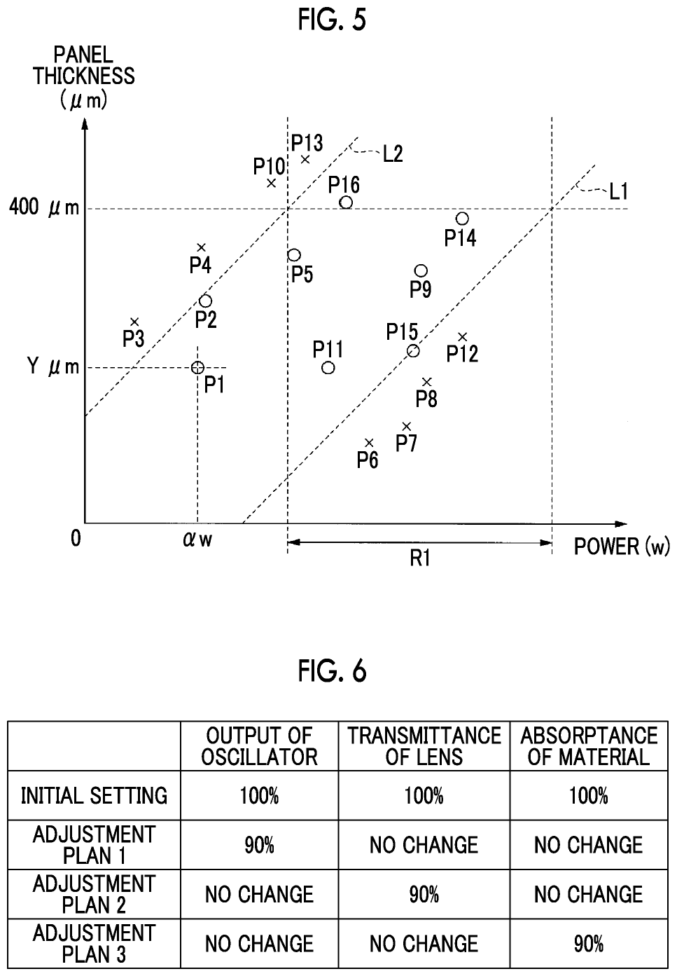

First, the user inputs the machining detail information to the simulation device 10. Then, the input/output unit 11 receives the input (step S21), and outputs the machining detail information to the simulation execution unit 12. The simulation execution unit 12 inputs the input machining detail information to the simulation model as a machining result, and calculates the range of the setting condition set in machining to obtain the machining result by an inverse analysis (step S22). Alternatively, the simulation execution unit 12 calculates the range of the setting condition on the basis of the machining result information indicating machining characteristics. Here, the range of the setting condition will be described with reference to FIG. 5.

FIG. 5 is a diagram explaining a range of the setting condition in the first embodiment according to the present invention. A graph of FIG. 5 is a graph showing a relationship between power (the setting condition) which is the output of the laser, and a panel thickness (the machining detail) when a hole of a prescribed diameter is made in a panel made of Si by the laser machining apparatus (the machine tool 3). A vertical shaft of the graph of FIG. 5 indicates a thickness (μm) of the panel, and a horizontal shaft indicates the power (w) of the laser. Marks of P1 to P16 in the graph indicate the machining result when performing machining that the laser is output at the power indicated by coordinates on the horizontal shaft where the marks are located and the hole is formed in a Si panel having the panel thickness indicated by coordinates on the vertical shaft. Marks o and x indicate whether or not each machining was successful or failed. Specifically, the mark indicates a result satisfying the machining detail (a success), and the mark “x” indicates a result not satisfying the machining detail (a failure). For example, the mark P1 indicates that a hole satisfying the prescribed machining detail, for example, a hole having a good hole diameter or quality is formed when a laser of a (W) is output to a copper panel having a panel thickness Y (μm) to perform drilling. From the machining result, when a boundary line that separates successful and unsuccessful machining is calculated using a prescribed method (a statistical analysis, machine learning, or the like), for example, boundary lines L1 and L2 are obtained. A region sandwiched between the boundary lines L1 and L2 is considered to be a range of an appropriate value that can be set to the setting condition “power” to realize desired machining. According to the idea, for example, when machining a Si panel having the panel thickness of 400 μm, a range R1 sandwiched between the boundary lines L1 and L2 on the vertical shaft of 400 μm is considered to be an appropriate range of the laser power.

The storage unit 16 of the simulation device 10 receives the machining result information, and the machining detail information and the setting condition information in the machining from the machine tool 3, and stores a large number of them as illustrated in FIG. 5. The simulation execution unit 12 calculates the range (R1) of the setting condition according to the calculation processing of the boundary lines L1 and L2 and the machining detail information (for example, the panel thickness of 400 μm). The simulation execution unit 12 stores the range information of the calculated setting condition in the storage unit 16.

Machining related to the marks P1 to P16 is performed under various conditions. For example, there are various types depending on a purity of Si which is the material of the member, a type and content of components other than Si, a manufacturing method, and the like. Alternatively, there are various environments in which the machine tool 3 performs machining. The simulation execution unit 12 specifies the range of the setting condition on the basis of the machining results under various conditions that are not uniform. Thereby, the simulation execution unit 12 can calculate the range of the setting condition in consideration of a disturbance that affects the machining result such as the installation environment of the machine tool and an individual difference of the object to be machined.

For example, the machining results indicated by the marks P1 to P16 may be associated with information such as a machining time, a machining place, the material of the object to be machined, the machining environment (a temperature, a humidity, a vibration, and the like), the type and model number of machine tool 3, a total operating time since machine tools were introduced (a machining time) in addition to the machining detail information (the panel thickness and the like) and the setting condition information (the power and the like). Then, the simulation execution unit 12 may specify the range of the setting condition by extracting only the machining result of the same material (for example, Si member having high purity) from the marks P1 to P16 on the basis of detail information of the material of the object to be machined included in the input machining detail information. Alternatively, the input/output unit 11 receives input of information on the machining environment together with the machining result information, and the simulation execution unit 12 extracts only a machining result when machining is performed in the machining environment similar to the input machining environment, and thereby the range of the setting condition may be calculated. As a result, it is possible to calculate a more limited range of the setting condition in accordance with an actual machining condition. Further, the user of the machine tool 3 is finally required to find the appropriate setting condition, but can leave the specification of the range including an appropriate setting condition to the simulation execution unit 12.

In addition to the machining result illustrated in FIG. 5, the storage unit 16 stores, for example, the machining result information and the like indicating a relationship between the power and the hole depth for each material, and the simulation execution unit 12 calculates the range of the appropriate value for other setting conditions that can be inversely analyzed from the machining result information. Then, the simulation execution unit 12 sets common ranges thereof as ranges for the setting condition “power”.

Here, the range of the setting condition is calculated by an inverse analysis or the like, but the setting condition (one value) may be calculated by an inverse analysis or the like. In this case, for example, the simulation execution unit 12 may use a median value of the range of the setting condition calculated by the above-described method and an average value of the setting condition corresponding to the machining result information included in the range as the value of the setting condition calculated by an inverse analysis. In addition, the simulation execution unit 12 may extract the machining result information closest to the machining detail to be currently simulated, and set the value of the setting condition corresponding to the machining result as the value of the setting condition calculated by an inverse analysis.

Returning to the description of the flowchart of FIG. 4. Next, the user inputs the information requesting execution of the simulation to the simulation device 10. Then, the input/output unit 11 receives the input of the simulation execution request (step S23), and the simulation execution unit 12 inputs the machining detail information input in step S21 and a representative value (for example, a median value) of the range calculated for each setting condition in step S22 to the simulation model. In addition, the simulation execution unit 12 sets a prescribed initial value to the internal parameters, for example, in the manner described in FIG. 3. Alternatively, in a case where the storage unit 16 stores internal parameters optimized for a condition similar to the machining detail information and the setting condition information in the current simulation, the simulation execution unit 12 may read out and set the value. Next, the simulation execution unit 12 executes the machining simulation on the basis of the simulation model (step S24), and calculates the simulation result. The simulation execution unit 12 outputs the simulation result information to the machining result evaluation unit 13.

Further, the simulation execution unit 12 transmits the setting condition information used at the time of the simulation to the machine tool 3 via the communication unit 17. In the machine tool 3, the communication unit 36 of the control device 30 receives the setting condition information, and outputs the setting condition information received to the machining device control unit 34. In addition, the CAD system 2 inputs the CAD data including the machining detail information input to the simulation device 10 to the control device 30 by the user operation. The input/output unit 31 outputs the CAD data to the CAM system 32. Further, the user inputs an operation for instructing the device to execute machining to the control device 30. Then, the machine tool 3 executes the machining under the same conditions as the simulation in step S24 (step S25). Specifically, the CAM system 32 generates NC data from the machining detail information, and the machining device control unit 34 controls the operation of the machining device 38 on the basis of the NC data and the setting condition information to execute machining.

In the flowchart of FIG. 4, the case where machining by the machine tool 3 is executed in step S25 under the same condition as the simulation executed in step S24 has been described as an example. However, after deciding that the machine tool 3 performs machining under the setting condition selected by the user, the selected setting condition may be acquired by the simulation device 10 and the simulation may be performed on the basis of the setting condition acquired by the simulation execution unit 12.

When machining is ended, the sensor 39 measures the machining result (step S26). The sensor data processing unit 33 analyzes the image of the machining result photographed by the camera (the sensor 39), calculates the shape of the object to be machined (for example, the diameter of the inlet and the diameter of the outlet), and calculates the quality of the object to be machined (the surface roughness).

In addition, the sensor 39 measures information on the internal parameters of the simulation model. For example, the power of the laser light output from the head and power of reflected light reflected on the surface of the object to be machined are measured using a power meter (the sensor 39). In addition, the sensor data processing unit 33 analyzes the image of the machining result, and calculates width and size of a machining trace by the laser. The power of the laser light measured by the power meter is related to the performance value of the oscillator and lens among the internal parameters, and the power of the reflected light measured by the power meter is related to the absorptance of the material among the internal parameters. In addition, the width of the machining trace is related to the beam diameter among the internal parameters. When optimizing the simulation model on-line as described later, the measured value of the items related to the internal parameters in the actual machine can be used for adjusting the internal parameters.

The sensor data processing unit 33 transmits the calculated machining result information (the shape and the quality) and information on the internal parameters to the simulation device 10 via the communication unit 36. In the simulation device 10, the machining result evaluation unit 13 acquires machining result information via the communication unit 17.

The machining result evaluation unit 13 compares the machining result information with the simulation result information to evaluate the degree of coincidence (step S27). The evaluation method is the same as step S14 in FIG. 3. In a case where the degree of coincidence of all items to be evaluated with respect to the machining result is equal to or more than a threshold value (step S27; Yes), the simulation execution unit 12 stores the currently set internal parameters in the storage unit 16 in association with the machining detail information, the setting condition information, the simulation result information, and the degree of coincidence (step S28), and ends the processing of the flowchart.

In a case where there are the items of which the degree of coincidence is less than a threshold value (step S27; No), the model optimization unit 14 adjusts the internal parameters (step S29). Here, a method of adjusting the values of the internal parameters using the measurement information on the internal parameters measured in step S26 will be described with reference to FIG. 6. FIG. 6 is a diagram explaining adjustment processing of an internal parameter in the first embodiment according to the present invention. FIG. 6 shows an example of the internal parameters. “The output of the oscillator” and “the transmittance of the lens” are examples of the internal parameters related to the performance and the like of machine tool 3, and “the absorptance of the material” is an example of the internal parameters related to the material. For convenience of explanation, it is assumed that each parameter is set to 100% as an initial setting. “The output of the oscillator” of 100% means that when the power of the laser is set to 100 W under the setting condition, the simulation model performs the simulation under the assumption that the laser light of 100 w is output from the oscillator. Similarly, “the transmittance of the lens” of 100% means that it is assumed that the laser light of 100 w output from the oscillator is output from the head as 100 w without being attenuated, and “the absorptance of the material” of 100% means that the simulation is executed under the assumption that all of the laser light of 100 w output from the head is absorbed by the object to be machined.

The model optimization unit 14 acquires information on internal parameters from the machining result evaluation unit 13 and adjusts the internal parameters. For example, in a case where the power of the laser measured in the head is 90 W even though the power of the laser set in the setting condition is 100 w, the model optimization unit 14 sets, for example, the internal parameters “the output of the oscillator” to 90% (adjustment plan 1). Alternatively, the model optimization unit 14 may set the internal parameters “the transmittance of the lens” to 90% (adjustment plan 2). Alternatively, the model optimization unit 14 may set, for example, each of “the output of the oscillator” and “the transmittance of the lens” to 95%. With the adjustment, it is possible to execute the machining simulation under the assumption that only 90 w is actually output even though the setting condition is set to 100 w, and perform a simulation close to machining actually performed by the machine tool 3.

Further, for example, in a case where it is assumed that a total of absorbed light and reflected light is a total output without considering the light transmitted through the object to be machined when the reflectance by the object to be machined measured by the power meter is 10%, since it is considered that 90% of the laser power output from the head is absorbed by the object to be machined, the model optimization unit 14 sets the internal parameters “the absorptance of the material” (adjustment plan 3) to 90%. By the adjustment, even though the laser of 100 w is output, the machining simulation can be executed, and machining close to the case actually performed by the machine tool 3 can be simulated under the assumption that only 90 w is actually absorbed by the object to be machined due to the influence of the shape of the object to be machined and the like, for example.

For example, in a case where the initial setting value of the internal parameters “the beam diameter” is Z and the width of the machining trace obtained by the image analysis is about 80%, the model optimization unit 14 sets the internal parameters “the beam diameter” to 80%.

It is possible to construct a simulation model more suitable for reality and improve the accuracy of the machining simulation by optimizing the simulation model on the basis of the information on the internal parameters obtained from the result of the actual machining by the machine tool 3. After adjusting the internal parameters, the simulation execution unit 12 performs the simulation again using the adjusted simulation model without changing the machining detail information and the setting condition information (step S30). The model optimization unit 14 repeatedly executes the calculation of the simulation result while changing the internal parameters until the degree of coincidence between the machining result information and the simulation result information becomes equal to or more than a threshold value.

When the degree of coincidence becomes equal to or more than a threshold value, the simulation execution unit stores the internal parameters, the machining detail information, the setting condition information, the simulation result information, and degree of coincidence in the storage unit 16 in association with each other. In addition, the input/output unit 11 displays a fact that the optimization of the simulation is ended on the display to notify the user. The input/output unit 11 displays the range of the setting condition calculated by the simulation execution unit 12 on the display to notify the user. The user refers to the range of the setting condition for each of the displayed setting conditions, selects a random value from the range, and inputs the value to the simulation device 10. Further, the user inputs the machining detail information to be performed to the simulation device 10. Then, the simulation result is obtained using the simulation model optimized by causing the simulation execution unit 12 to execute the machining simulation. The user adjusts the setting condition until the simulation result matches the desired machining result. Thereby, the user can obtain appropriate setting condition.

In addition, for example, in a case where the internal parameters are adjusted for prescribed number of times, but the result that the degree of coincidence is equal to or more than a prescribed threshold value is not obtained, a warning message may be notified and the optimization processing may be stopped. Further, since the range of the setting condition calculated in step S22 is the range obtained by performing an inverse analysis on the basis of the model before optimizing the internal parameters, the range of the setting condition may be inappropriate. Therefore, after optimizing the internal parameters, the range of the setting condition is calculated again by the inverse analysis using the simulation model that sets the optimized internal parameters and a process of performing processing after step S22 is repeated several times. For example, an embodiment in which the value of the internal parameters in a process with the highest degree of coincidence is adopted may be used.

According to the method for optimizing the machining simulation on-line described with reference to FIGS. 4 to 6, the accuracy of the simulation model can be improved and the machining simulation having the high accuracy can be performed by adjusting the internal parameters by using the information on the internal parameters measured by the actual machine. In addition, since the simulation model is optimized while comparing it with the current machining result by the machine tool 3 and the measured value related to the internal parameters, a model can be constructed on the basis of a change due to aging and the like. In addition to optimizing the simulation, the range of the setting condition is calculated, and the information can be provided to the user of the machine tool 3. Therefore, since the user only needs to find the setting condition from the range of the setting condition set in consideration of the disturbance, an appropriate setting condition can be set efficiently in a shorter time, and the efficiency of the machining operation can be improved.

In addition, it should be noted that the method of optimizing the machining simulation described above can, of course, be executed even when the range of the setting condition is not presented to the user of the machine tool 3. In this case, machining and simulation are executed on the basis of the setting condition selected by the user, and the degree of coincidence of the results is evaluated.

### Second Embodiment

In the first embodiment, the model optimization unit improves the accuracy of the machining simulation due to the simulation execution unit 12 by adjusting the internal parameters of the simulation model. In the second embodiment, the value of the internal parameters when the degree of coincidence between the machining result information and the simulation result information is equal to or more than a prescribed threshold value is learned, and the accuracy of the simulation model is further increased.

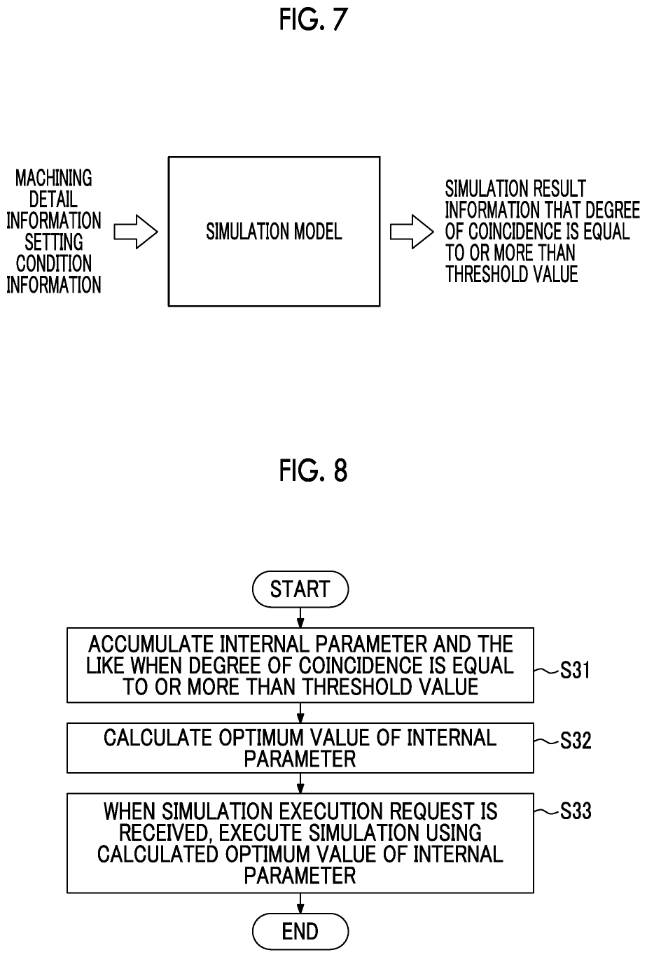

FIG. 7 is a diagram explaining optimization processing of a simulation model in a second embodiment according to the present invention.

As shown in figs, when the optimization of the simulation is repeatedly performed by the method of the first embodiment described with reference to FIGS. 3 and 4, for certain machining detail information and setting condition information, a plurality of sets of the internal parameters is obtained such that the degree of coincidence between the machining result information and the simulation result information is equal to or more than a prescribed threshold value. The storage unit 16 stores the plurality of the sets of the internal parameters obtained as described above. For example, among the internal parameters, examples of combinations of the values of “the output of the oscillator”, “the transmittance of the lens”, and “the absorptance of the material” (the sets of the internal parameters) and examples of the degree of coincidence when the simulation is executed with the combinations are shown below. Each of values is “the output of the oscillator”, “the transmittance of the lens”, “the absorptance of the material”, and “the degree of coincidence” in order from the left.

TABLE 1

| | Output of | Transmittance | Absorptance | Degree of |
|---|---|---|---|---|
| | oscillator | of lens | of material | coincidence |
| Internal | 90% | 100% | 80% | 95% |
| parameter set 1 | | | | |
| Internal | 95% | 95% | 85% | 96% |
| parameter set 2 | | | | |
| Internal | 100% | 90% | 80% | 92% |
| parameter set 3 | | | | |
| Internal | 95% | 90% | 80% | 98% |
| parameter set 4 | | | | |

The learning unit 15 learns the internal parameter sets 1 to 4 and calculates the optimum values of each of the internal parameters “the output of the oscillator”, “the transmittance of the lens”, and “the absorptance of the material”. For example, the learning unit 15 calculates an average value of four internal parameter sets, and the average value may be set as the optimum value of each internal parameter. Alternatively, the learning unit 15 may calculate a weighted average according to the degree of coincidence and use the average as the optimum value of each internal parameter. (For example, the optimum value of “the output of the oscillator” may be calculated by (90%×95%+95%×96%+100%×92%+95%×98%)=4.

Alternatively, using the machining detail information, the setting condition information, and the simulation result information when the degree of coincidence is equal to or more than an threshold value as teacher data, the learning unit 15 may construct a logical model that outputs the simulation result information by methods of machine learning or deep learning (for example, a neural network and the like) when inputting the machining detail information and the setting condition information.

FIG. 8 is a flowchart showing an example of optimization processing of a simulation model in the second embodiment according to the present invention.

First, the simulation execution unit 12 performs the optimization processing of the simulation model described in FIGS. 3 and 4, and the storage unit 16 accumulates the machining detail information, the setting condition information, the simulation result information, and the value of the internal parameters, and the degree of coincidence in association with each other when the degree of coincidence between the machining result information and the simulation result information is equal to or more than a prescribed threshold value (step S31).

Next, the learning unit 15 learns a relationship between the machining detail information, the setting condition information, and the internal parameters, and calculates the optimum value of the internal parameters for each of the machining detail information and the setting condition information (step S32). As a method of calculating the optimum value, for example, a method may be used in which the learning unit 15 performs grouping for data in which the values of each item of the machining detail information and the setting condition information are similar and sets an average value of the values of internal parameters of data belonging to the same group or a weighted average value according to the degree of coincidence as an optimum value. The learning unit 15 stores the calculated optimum value of the internal parameters in the storage unit 16 in association with the values of the machining detail information and the setting condition information for being classified into the group.

Next, when a simulation execution request is received, the simulation is executed using the calculated optimum values of the internal parameters (step S33). Specifically, on the basis of the machining detail information and the setting condition information input with the simulation execution request, the simulation execution unit 12 determines to which group classified in step S32 the machining detail information and the setting condition information in the current simulation correspond, reads out the optimum values of the internal parameters set for the group determined to correspond from the storage unit 16, and sets the optimum values in the simulation model together with the machining detail information and the setting condition information.

Then, the simulation execution unit 12 executes the simulation. According to the present embodiment, the simulation having higher accuracy can be executed. Therefore, the more appropriate setting condition can be selected.

In the above-described embodiment, the case where the machine tool 3 is the laser machining apparatus has been described as an example. However, the machine tool 3 is not limited to the laser machining apparatus, but may be other machining apparatus such as a machining center or an NC lathe.

Various machining detail information and values of the internal parameters optimized for each the setting condition information are accumulated in the storage unit 16 of the simulation device 10, a service may be provided to the user as a simulator template combining the machining detail information, the setting condition information, and the optimized internal parameters. For example, the input/output unit 11 displays a screen for selecting a language, and when the language is selected, displays a screen in which an input field for machining detail information and the setting condition information, a selection field of the template, a simulation execution instruction button, and the like are displayed in the selected language. When the input of the machining detail information and the like and the input of the simulation execution instruction are received, the simulation execution unit 12 inputs the input machining detail information and the like to the simulation model, and further sets the values of the internal parameters in the selected template in the simulation model and executes the simulation. Then, the input/output unit 11 displays the simulation result information by the simulation execution unit 12 on the display. In a case where a desired simulation result is obtained, the simulation device 10 may add the machining detail information, the setting condition information, and the internal parameters used in the current simulation to the template as a new simulator. Alternatively, the simulation device 10 and a billing system may be linked to charge each time the user performs the simulation.

Similarly, a service may be provided in which the user inputs the machining detail information, the setting condition information, and the machining result information to optimize the simulation and provide the simulator after the optimization. Thereby, the user can perform the simulation using the simulation model applied to the machine tool 3 that is usually used.

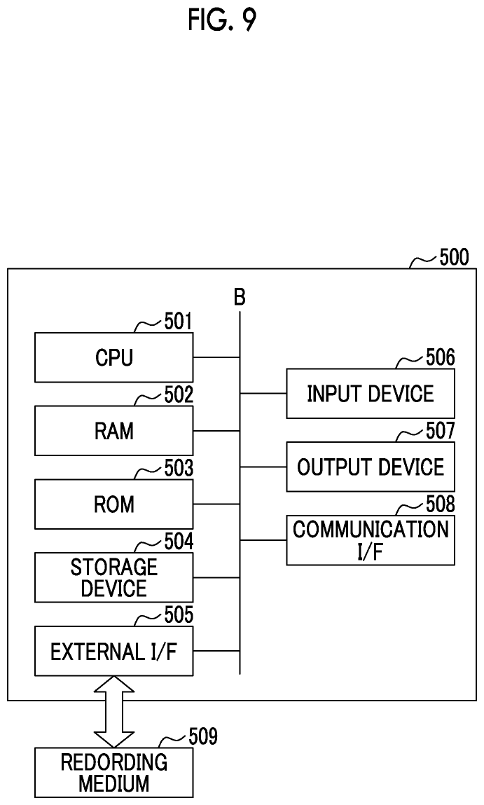

(Configuration of Hardware) The simulation device 10 can be realized using a general computer 500. FIG. 9 shows an example of a configuration of the computer 500.

FIG. 9 is a diagram showing an example of a hardware configuration of a simulation device according to the present invention.

The computer 500 includes a central processing unit (CPU) 501, a random access memory (RAM) 502, a read only memory (ROM) 503, a storage device 504, an external I/F (Interface) 505, an input device 506, an output device 507, a communication I/F 508, and the like. The devices mutually transmit and receive signals via a bus B.

The CPU 501 is an arithmetic device that realizes each function of the computer 500 by reading out programs and data stored in the ROM 503, the storage device 504, and the like onto the RAM 502 and executing processing. For example, each of the above-described functional units is a function included in the computer 500 when the CPU 501 reads and executes a program stored in the ROM 503 or the like. The RAM 502 is a volatile memory used as a work area of the CPU 501 and the like. The ROM 503 is a non-volatile memory that retains programs and data even when the power is turned off. The storage device 504 is realized by, for example, a hard disk drive (HDD), a solid state drive (SSD), and the like and stores an operation system (OS), an application program, and various data. The external I/F 505 is an interface with an external device. The external device includes a storage medium 509, for example. The computer 500 can read and write the storage medium 509 via the external I/F 505. The storage medium 509 includes, for example, an optical disk, a magnetic disk, a memory card, a universal serial bus (USB) memory, and the like.

The input device 506 includes, for example, a mouse, a keyboard, and the like, and inputs various operations to the computer 500 in response to an operator's instruction. The output device 507 is realized by, for example, a liquid crystal display, and displays a processing result by the CPU 501. The communication I/F 508 is an interface that connects the computer 500 to a network such as internet by wire communication or wireless communication. The bus B is connected to each of the above-described component devices, and transmits and receives various signals and the like between the component devices.

The process of each processing in the above-described simulation device 10 is stored in a computer-readable storage medium in the form of the program, and the above-described processing is performed by reading out and executing the program by the computer 500 mounted with the simulation device 10. Here, the computer-readable storage medium refers to a magnetic disk, a magneto-optical disk, a CD-ROM, a DVD-ROM, a semiconductor memory, or the like. Alternatively, the computer program may be distributed to a computer via a communication line, and the computer that has received the distribution may execute the program.

The above-described program may be for realizing some of the functions described above. Further, what can realize the above-described functions in combination with the programs already stored in the computer system, that is, a so-called a difference file (a difference program) may be used.

Further, the simulation device 10 may be configured by one computer, or may be configured by a plurality of computers communicably connected. Further, the functional units (the simulation execution unit 12, the machining result evaluation unit 13, the model optimization unit 14, the learning unit 15, and the storage unit 16) of the simulation device 10 may be mounted on the control device 30.

In addition, it is possible to appropriately replace the components in the above-described embodiment with known components without departing from the scope of the invention. The technical scope of the present invention is not limited to the above-described embodiment, and various modifications can be made without departing from the scope of the invention. The simulation device 10 is an example of the machining simulation device. The simulation system 1 is an example of the machining simulation system. In addition, the internal parameters of the simulation model are an example of a precondition for calculation. The simulation result information is an example of a first machining result, and the machining result information machined by the machine tool 3 is an example of a second machining result. The input/output unit 11 is an example of a reception unit. The simulation execution unit 12 is an example of a calculation unit. The communication unit 17 is an example of an acquisition unit. The machining result evaluation unit 13 is an example of an evaluation unit. The model optimization unit 14 is an example of a change unit. The machine tools 3a to 3e are examples of machining tools. Adjustment of the internal parameters of the simulation model is an example of the method of optimizing the condition of the machining simulation.

### INDUSTRIAL APPLICABILITY

According to the above-described method of optimizing the machining simulation condition, the machining simulation device, the machining simulation system and the program, the machining simulation model that simulates machining of the machine tool with high accuracy can be constructed.

### REFERENCE SIGNS LIST

1: simulation system
2, 2a, 2b: CAD system
3, 3a, 3b: machine tools
10: simulation device
11: input/output unit
12: simulation execution unit
13: machining result evaluation unit
14: model optimization unit
15: learning unit
16: storage unit
17: communication unit
30: control device
31: input/output unit
32: CAM system
33: sensor data processing unit
34: machining device control unit
35: setting condition determination unit
36: communication unit
37: storage unit
38: machining device
39: sensor

1. A method of optimizing a machining simulation condition by a computer, the method comprising:
a step of receiving a setting condition of a machine tool at the time of performing a prescribed machining detail;
a step of calculating a first machining result that is a machining result assumed when the machine tool performs machining under the received setting condition;
a step of causing the computer to acquire a second machining result that is a machining result when the machine tool performs machining under the received setting condition;
a step of evaluating a degree of coincidence between the first machining result and the second machining result; and
a step of changing a precondition of the calculation,
wherein the computer repeatedly executes the calculation of the first machining result while changing the precondition of the calculation until the degree of coincidence is equal to or more than a prescribed threshold value.

2. The method of optimizing the machining simulation condition according to claim 1,
wherein in the step of changing the precondition of the calculation, the precondition of the calculation is adjusted on the basis of measurement information on the precondition of the calculation measured when the machine tool performs machining under the setting condition.

3. The method of optimizing the machining simulation condition according to claim 1,
wherein in the step of calculating the first machining result, the machining detail and the setting condition are input and the first machining result is calculated on the basis of a prescribed machining simulation model.

4. The method of optimizing the machining simulation condition according to claim 3,
wherein the setting condition is a value that is calculated by an inverse analysis on the basis of the machining simulation model and the machining detail.

5. The method of optimizing the machining simulation condition according to claim 3,
wherein the setting condition is a representative value of a range of the setting condition that is calculated by an inverse analysis on the basis of the machining simulation model and the machining detail.

6. The method of optimizing the machining simulation condition according to claim 3,
wherein the precondition of the calculation includes at least one of a parameter related to a performance of the machine tool included in the machining simulation model and a parameter related to a material of an object to be machined included in the machining simulation model.

7. The method of optimizing the machining simulation condition according to claim 1, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

8. The method of optimizing the machining simulation condition according to claim 3,
wherein the machine tool is a laser machining apparatus.

9. A machining simulation device comprising:
a reception unit that receives a setting condition of a machine tool at the time of executing a prescribed machining detail;
a calculation unit that calculates a first machining result that is a machining result assumed when the machine tool performs machining under the received setting condition;
an acquisition unit that acquires a second machining result that is a machining result when the machine tool performs machining under the received setting condition;
an evaluation unit that evaluates a degree of coincidence between the first machining result and the second machining result; and
a change unit that changes a precondition of the calculation,
wherein the calculation unit repeatedly performs the calculation of the first machining result while changing the precondition of the calculation until the degree of coincidence is equal to or more than a prescribed threshold value.

10. A machining simulation system comprising:
a machine tool; and
the machining simulation device according to claim 9,
wherein the machining simulation device acquires a machining detail and a setting condition in machining executed by the machine tool to optimize a machining simulation condition.

11. A program for causing a computer to execute a method of optimizing a machining simulation condition, the program causes a computer to execute
a step of receiving a setting condition of a machine tool at the time of executing a prescribed machining detail;
a step of calculating a first machining result that is a machining result assumed when the machine tool performs machining under the received setting condition;
a step of causing the computer to acquire a second machining result that is a machining result when the machine tool performs machining under the received setting condition;
a step of evaluating a degree of coincidence between the first machining result and the second machining result; and
a step of changing a precondition of the calculation,
wherein the computer repeatedly performs the calculation of the first machining result while changing the precondition of the calculation until the degree of coincidence is equal to or more than a prescribed threshold value.

12. The method of optimizing the machining simulation condition according to claim 2,
wherein in the step of calculating the first machining result, the machining detail and the setting condition are input and the first machining result is calculated on the basis of a prescribed machining simulation model.

13. The method of optimizing the machining simulation condition according to claim 4,
wherein the precondition of the calculation includes at least one of a parameter related to a performance of the machine tool included in the machining simulation model and a parameter related to a material of an object to be machined included in the machining simulation model.

14. The method of optimizing the machining simulation condition according to claim 5,
wherein the precondition of the calculation includes at least one of a parameter related to a performance of the machine tool included in the machining simulation model and a parameter related to a material of an object to be machined included in the machining simulation model.

15. The method of optimizing the machining simulation condition according to claim 2, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

16. The method of optimizing the machining simulation condition according to claim 3, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

17. The method of optimizing the machining simulation condition according to claim 4, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

18. The method of optimizing the machining simulation condition according to claim 5, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

19. The method of optimizing the machining simulation condition according to claim 6, further comprising:
a step of accumulating the precondition of the calculation when the degree of coincidence is equal to or more than a prescribed threshold value; and
a step of calculating an optimum value of the precondition of the calculation on the basis of the accumulated precondition of the calculation.

20. The method of optimizing the machining simulation condition according to claim 4,
wherein the machine tool is a laser machining apparatus.
